(19) United States
(12) Patent Application Publication
(10) Pub. No.: US 2006/0043957 A1
(43) Pub. Date: Mar. 2, 2006

(54) Resistance trimming in bandgap reference voltage sources

(76) Inventor: Carlos Manuel Carvalho, Nepean (CA)

Correspondence Address: SMART & BIGGAR/FETHERSTONHAUGH & CO.;P.O. BOX 2999, STATION D, 900-55 METCALFE STREET, OTTAWA, ON, K1P5Y6, CA

(21) Appl. No.: 10/928,140

(22) Filed: Aug. 30, 2004

(51) Int. Cl. G05F 3/16

(52) U.S. Cl. 323/313

(57) ABSTRACT

A curvature-compensated bandgap reference is provided in an integrated circuit using CMOS technology. Resistors of the bandgap reference to be trimmed for determining a temperature slope and absolute value of a reference voltage produced by the bandgap reference are implemented by resistor network and switch units in which switches are controlled by an external test unit via decoders on the IC to provide different resistance values for the resistors, in dependence upon measurements of the reference voltage. Resistor trimming is facilitated by a method using an on-chip heater for the bandgap reference.

This invention relates to resistance trimming in a curvature-compensated bandgap reference voltage source, also referred to below as a bandgap reference.

### BACKGROUND

Bandgap references are used in many electronic circuits and applications to provide stable and relatively accurate voltage references, for example for A-D (analog-to-digital) and D-A (digital-to-analog) converters.

A bandgap reference is an integrated circuit (IC), by itself or forming part of a larger IC device, which has large variations of temperature dependency and absolute voltage for different dies and different semiconductor wafers. In view of this, bandgap references are generally trimmed, preferably at the wafer level or on packaged ICs, making use of large temperature-controlled ovens in arrangements that can process and trim several ICs at the same time. These techniques are costly and time-consuming, and in the case of wafer-level trimming do not take into account stresses from packaging that can degrade the performance of the bandgap references.

“A Curvature-Corrected Low-Voltage Bandgap Reference” by M. Gunawan et al., IEEE Journal of Solid-State Circuits, Vol. 28, No. 6, pages 667-670, June 1993, describes a bandgap reference with a low temperature coefficient achieved by so-called curvature correction of the non-linear temperature dependence of a base-emitter voltage of a bipolar transistor. “Curvature-Compensated BiCMOS Bandgap With 1-V Supply Voltage” by P. Malcovati et al., IEEE Journal of Solid-State Circuits, Vol. 36, No. 7, pages 1076-1081, July 2001, describes a bandgap reference which is implemented in BiCMOS technology.

Such bipolar and BiCMOS arrangements are expensive and/or impractical to incorporate into a vast majority of IC devices which use CMOS technology. Trimming of such devices is typically performed using ovens or other external temperature control arrangements as described above.

It is also known to provide a voltage reference source with an on-chip heater which is controlled to heat the source to a constant temperature greater than the ambient temperature thereby to provide a precise reference voltage. For example, the LTZ1000A device from Linear Technology Corporation provides a Zener reference, a heater resistor for temperature stabilization, and a temperature-sensing transistor in a thermally-insulated arrangement. Again, this uses bipolar technology. As illustrated in the data sheet for this device, such bipolar arrangements also have an initial variation of the reference voltage over a period of several days.

Reay et al. U.S. Pat. No. 5,600,174 issued February 4, 1997 and entitled “Suspended Single Crystal Silicon Structures And Method Of Making Same” describes a temperature-regulated bandgap reference using vertical bipolar transistors which can be realized in a CMOS process. In this arrangement the voltage reference is thermally isolated by being suspended by dielectric beams over an etched pit, and is heated to an above-ambient temperature which is regulated by a closed-loop control arrangement. Such an arrangement involves a relatively high cost for etching of the wafer.

There remains a need to provide an improved bandgap voltage reference source at a relatively low cost and with a good accuracy, that can be easily incorporated into IC devices using CMOS technology, and a need to facilitate resistance trimming in such a reference voltage sources.

### SUMMARY OF THE INVENTION

One aspect of this invention provides an integrated circuit comprising: a circuit for producing a reference voltage at an output of the integrated circuit, the reference voltage being dependent upon a resistance of a resistor; and a resistor network and switch unit constituting said resistor, the resistor network and switch unit comprising a plurality of resistors and a plurality of switches; the plurality of switches being responsive to control signals supplied to the integrated circuit to interconnect the plurality of resistors to provide different resistance values for said resistor.

In one arrangement, the plurality of resistors are connected in series and the plurality of switches are arranged for selectively bypassing different ones of the plurality of resistors. In another arrangement, the reference voltage is dependent upon a temperature of the reference voltage circuit, the resistance of said resistor determines a temperature dependence characteristic of the reference voltage, and the integrated circuit includes a heater for selectively heating the reference voltage circuit.

Another aspect of the invention provides an integrated circuit comprising: a bandgap reference voltage source for producing a reference voltage at an output of the integrated circuit, the reference voltage being dependent upon a temperature of the bandgap reference voltage source with a characteristic dependent upon a resistance of a resistor of the bandgap reference voltage source; and a resistor network and switch unit constituting said resistor, the resistor network and switch unit comprising a plurality of resistors and a plurality of switches; the plurality of switches being responsive to control signals supplied to the integrated circuit to interconnect the plurality of resistors to provide different resistance values for said resistor.

The integrated circuit preferably includes a heater for selectively heating the bandgap reference voltage source, and preferably also includes a decoder for producing decoded signals for controlling the plurality of switches from said control signals supplied to the integrated circuit.

In one form of the integrated circuit an absolute value of the reference voltage is dependent upon a resistance of a second resistor of the bandgap reference voltage source, the integrated circuit including a second resistor network and switch unit constituting said second resistor and comprising a plurality of resistors and a plurality of switches, the plurality of switches being responsive to control signals supplied to the integrated circuit to interconnect the plurality of resistors to provide different resistance values for said second resistor. In this case the integrated circuit can include a second decoder for producing decoded signals for controlling the plurality of switches of the second resistor network and switch unit from said control signals supplied to the integrated circuit.

The bandgap reference voltage source preferably includes a curvature compensation circuit for compensating for variation of the reference voltage with temperature.

The integrated circuit is preferably implemented using CMOS technology.

A further aspect of the invention provides a method of determining a resistance value of a resistor in a circuit for producing a reference voltage, the circuit being part of an integrated circuit also including a heater for heating the reference voltage circuit, the reference voltage having a dependence upon temperature determined by the resistance value of said resistor, comprising the steps of: determining said dependence upon temperature from two measurements of the reference voltage at different temperatures with a temperature difference determined by a controlled heating of the reference circuit using said heater; determining, from the determined dependence upon temperature, a resistance value of said resistor to minimize the temperature dependence of the reference voltage; and setting the resistance value of said resistor to the determined resistance value.

The step of setting the resistance value of said resistor to the determined resistance value can comprise controlling switches of a resistor network and switch unit constituting said resistor, and the step of controlling switches can comprise supplying control signals to the integrated circuit and decoding the control signals in a decoder of the integrated circuit.

Preferably the two measurements of the reference voltage at different temperatures are at an ambient temperature and at a temperature above ambient temperature produced by supplying a predetermined voltage to said heater.

To facilitate resistance value trimming of multiple integrated circuits from a semiconductor wafer, the method can include an initial step, for one of the integrated circuits from the wafer, of determining a temperature rise produced by supplying said predetermined voltage to said heater, said initial step comprising the steps of: determining said dependence upon temperature from measurements of the reference voltage at different temperatures determined externally of the integrated circuit; and determining said temperature rise from the determined dependence upon temperature and measurements of the reference voltage with and without said predetermined voltage supplied to said heater.

Another aspect of the invention provides a method of determining a resistance value of a resistor in a circuit for producing a reference voltage, the circuit being part of an integrated circuit, the reference voltage being dependent upon the resistance value of said resistor, comprising the steps of: measuring the reference voltage at an output of the integrated circuit; determining from the measured reference voltage a resistance value of said resistor to produce a desired value of the reference voltage; and setting the resistance value of said resistor to the determined resistance value by controlling switches of a resistor network and switch unit constituting said resistor. Preferably the step of controlling switches comprises supplying control signals to the integrated circuit and decoding the control signals in a decoder of the integrated circuit.

### BRIEF DESCRIPTION OF THE DRAWINGS

The invention will be further understood from the following description by way of example with reference to the accompanying drawings, in which:

FIG. 1 schematically illustrates a circuit of a bandgap reference;

FIG. 2 is a graph illustrating temperature dependence and substantially ideal curvature correction of the bandgap reference of FIG. 1;

FIG. 3 illustrates, in association with a test and control unit, an integrated circuit including a bandgap reference in accordance with an embodiment of this invention;

FIG. 4 illustrates one form of a resistor network and switch unit of the IC of FIG. 3;

FIG. 5 illustrates one form of another resistor network and switch unit of the IC of FIG. 3; and

FIGS. 6 and 7 are flow diagrams illustrating resistor trimming steps in a method in accordance with an embodiment of the invention.

### DETAILED DESCRIPTION

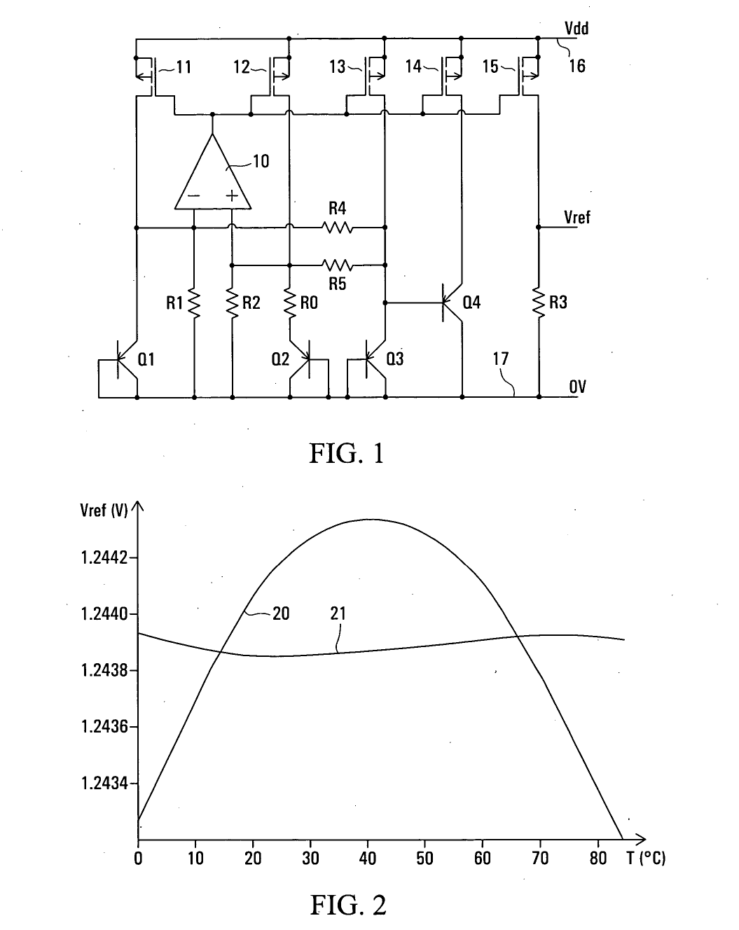

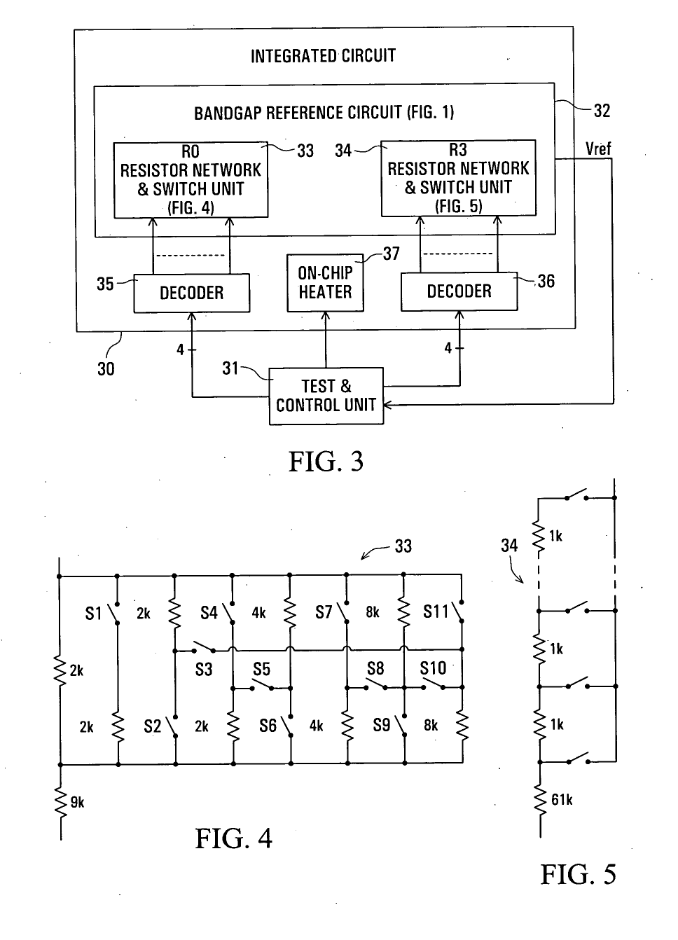

Referring to the drawings, FIG. 1 illustrates a circuit of a bandgap reference. The circuit comprises bipolar PNP transistors Q1 to Q4, resistors R0 to R5, a differential amplifier 10, and P-channel MOSFETs 11 to 15 all of which have their gates connected to an output of the amplifier 10 and their sources connected to a rail 16. The rail 16 is supplied with a positive supply voltage Vdd relative to a zero voltage 0V supplied to another rail 17 to which the collectors of the transistors Q1 to Q4 are connected. The transistors Q1 to Q3 are diode-connected by also having their bases connected to the rail 17.

An inverting (−) input of the amplifier 10 is connected to the emitter of the transistor Q1, to the drain of the transistor 11, and via the resistor R1 to the rail 17. A non-inverting (+) input of the amplifier 10 is connected via the resistor R0 to the emitter of the transistor Q2, to the drain of the transistor 12, and via the resistor R2 to the rail 17. An output voltage Vref of the bandgap reference is derived from the drain of the transistor 15, which is connected via the resistor R3 to the rail 17. The drain of the transistor 14 is connected to the emitter of the transistor Q3, via the resistors R4 and R5 to the inverting and non-inverting inputs, respectively, of the amplifier 10, and to the base of the transistor Q4. The emitter of the transistor Q4 is connected to the drain of the transistor 14.

The bandgap reference of FIG. 1 differs from that of FIG. 4 of the Malcovati et al. article referred to above in that the transistors Q4 and 14 are added as described below, and the transistors Q1 to Q3 are PNP transistors rather than NPN transistors as described in the article. The latter change facilitates incorporation of the bandgap reference in CMOS technology (compared with BiCMOS technology as in the Malcovati et al. article), in which vertical PNP bipolar transistors have characteristics which, although not good, are considerably better than the characteristics of lateral NPN bipolar transistors.

The diode-connected transistor Q2 has an emitter area that is about N=24 times that of the transistor Q1; the transistors Q2 and Q3 for example have the same emitter area as the transistor Q1. The transistors 11 to 15 all conduct the same current Ibg dependent on the output of the amplifier 10, which operates substantially to equalize the voltages at its inputs. This current passed by the transistor 15 produces a voltage drop across the resistor R3 which constitutes the bandgap reference voltage Vref.

Without the resistors R4 and R5 and the transistors Q3, Q4, 13, and 14 this current Ibg=(Vbe/R1)+(ΔVbe/R0), where R0 and R1 also represent the resistances of the respective resistors. Vbe is the base-emitter voltage of the transistor Q1, which has a first-order temperature dependency of about −1.5 mV/° C. ΔVbe is the difference in base-emitter voltages of the transistors Q1 and Q2, which for N=24 has a first-order temperature dependency of about 0.274 mV/° C. Thus first-order temperature compensation can be achieved by adjustment of the relative resistance values R0, R1, and R2, the resistance values R1 and R2 being nominally equal. FIG. 2 shows a line 20 illustrating variation of the output voltage Vref with temperature T, from 0° C. to 85° C., after such first-order temperature compensation.

The curved shape of the line 20 is due to a non-linear (logarithmic) dependence of the base-emitter voltage upon temperature. Compensation for this non-linear term is substantially provided by the arrangement of the resistors R4 and R5 and the transistors Q3, Q4, 13, and 14. Thus in the circuit of FIG. 1 the resistors R4 and R5 introduce a non-linear term of opposite sign, which substantially cancels the curvature of the line 20 to produce the output voltage Vref with very little dependence upon temperature, for example as shown by a line 21 in FIG. 2.

As explained in the article by Malcovati et al., the non-linear component of the base-emitter voltage dependence upon temperature is proportional to a value (n-α), where n is a parameter that depends upon the bipolar transistor structure, and is of the order of 4. The current in the bipolar transistors Q1 and Q2 is proportional to absolute temperature (PTAT), so that for these transistors the parameter α is equal to 1. In contrast, the current passed by each of the transistors 11 to 15 is first-order independent of temperature. The current passed by the transistor 13 is supplied to the diode-connected transistor Q3, so that for this transistor the parameter α is approximately zero.

These different values of a result in a difference, between the base-emitter voltage of the transistor Q3 and the base-emitter voltages of the transistors Q1 and Q2, dependent upon the non-linear component, which accordingly is compensated by currents conducted via the resistors R4 and R5, which have nominally equal resistance values for example of the order of R1/(n-1).

In reality, due to resistor temperature coefficients and other non-idealities, the value of a for the transistor Q3 is about 0.3 rather than 0. The transistor Q4 conducts a base current that is substantially the same as the base current of the transistor Q3; this transistor Q4 base current is conducted by the transistor Q3 to compensate for the base current of the transistor Q3, thereby making the collector current of the transistor Q3 more stable in terms of temperature variation.

In one example, with n=4.8 for a particular bipolar transistor model, final resistance values for the resistors, obtained by simulation, were R0=10 kΩ, R1=R2=54 kΩ, and R4=R5=9.5 kΩ. For a temperature variation from 0° C. to 85° C. this reduced the variation of the output voltage Vref of the bandgap reference from 1.1 mV to less than 0.1 mV, as shown in FIG. 2 by the lines 20 and 21 respectively.

In practice, implementing a bandgap reference as described above in an IC device, especially using CMOS technology, does not immediately produce such ideal results. The bipolar transistors typically have large variations which, with offset of the amplifier 10 and resistor mismatches, cause the bandgap reference to have very different temperature dependencies and absolute voltages from die to die.

More particularly, such variations are manifested as an overall (positive or negative) slope of the output voltage Vref with temperature instead of it being substantially flat as shown by the line 21 in FIG. 2, and a (positive or negative) offset of this output voltage, at a specific temperature, from a desired absolute value. It is known that these variations can be corrected by trimming of the resistances. Conveniently, the resistance value of the resistor R0 can be trimmed to correct the slope, and the resistance value of the resistor R3 can be trimmed to correct the absolute value of the output voltage Vref.

The article by Malcovati et al. describes implementing resistors to be trimmed in the form of a resistor network, comprising a fixed resistor in series with an array of resistors, with terminals of the network connected to external pins of the IC, enabling external connections among these pins to be made to vary the overall resistance of the network in small steps over a desired range.

However, this results in an undesirably large number of external connections, which must be made manually. Conventional trimming techniques can be used instead to trim the resistance values in known manner, but as explained in the Background above, these are costly and time-consuming, and in the case of wafer-level trimming do not take into account stresses from packaging that can degrade the performance of the bandgap-references.

FIG. 3 illustrates an integrated circuit, represented by a box 30, including a bandgap reference in accordance with an embodiment of this invention. The bandgap reference is illustrated in FIG. 3 as being connected to a test and control unit 31, which is used for trimming resistance values of the resistors R0 and R3 in a manner for example as described further below. The IC 30 can comprise any other circuits that may be desired, including for example A-D or D-A converters or other circuits which can make use of the reference voltage Vref produced by the bandgap reference.

The bandgap reference in the IC 30 of FIG. 3 comprises a bandgap reference circuit, represented by a box 32, which has the same form as described above with reference to FIG. 1. In the bandgap reference circuit 32 the resistor R0 of FIG. 1 is constituted by a resistor network and switch unit 33 which can for example be as described below with reference to FIG. 4, and the resistor R3 of FIG. 1 is constituted by another resistor network and switch unit 34 which can for example be as described below with reference to FIG. 5. Switches in the units 33 and 34 are controlled by respective decoders 35 and 36 of the IC 30. The IC 30 also includes an on-chip heater 37 for the bandgap reference. The on-chip heater 37 can be formed for example by a transistor or a resistor thermally coupled to the bandgap reference; these parts of the IC 30 may but need not be thermally isolated from other parts of the IC.

The test and control unit 31 provides a control or supply voltage for the on-chip heater 37, and provides 4-bit switch control signals to the decoders 35 and 36. It can be appreciated that although for simplicity and clarity FIG. 3 shows the switch control signals as being supplied to the decoders 35 and 36 via separate 4-bit-wide paths, the number of connections between the IC 30 and the unit 31 can be easily reduced by multiplexing these switch control signals for the decoders, or by supplying control signals from the unit 31 to the IC 30 via a serial interface.

FIG. 4 illustrates by way of example one form of the resistor network and switch unit 33 for providing a nominal resistance of about 10 kΩ for the resistor R0. As shown in FIG. 4, the unit 33 comprises a 9 kΩ resistor connected in series with a 2 kΩ resistor, the latter being selectively paralleled by various combinations of 2 kΩ, 4 kΩ, and 8 kΩ resistors in dependence upon the states of switches S1 to S11 which are controlled by outputs of the decoder 35, not shown in FIG. 4.

By way of example, the following table indicates switch control signal codes each of 4-bits supplied by the unit 31 to the decoder 35, which of the switches S1 to S11 are closed by corresponding output signals of the decoder, and resulting resistance values of the resistor R0:

| Code | Switches closed | R0 Value in kΩ |
|---|---|---|
| 0000 | S1, S2, S4, S6, S7, S9 | 9.381 |
| 0001 | S1, S2, S4, S9 | 9.471 |
| 0010 | S1, S2, S5, S8 | 9.572 |
| 0011 | S1, S2 | 9.667 |
| 0100 | S1, S6, S10 | 9.762 |
| 0101 | S1, S5 | 9.857 |
| 0110 | S1, S10 | 9.941 |
| 0111 | S6, S8, S11 | 10.043 |
| 1000 | S7, S9 | 10.143 |
| 1001 | S5, S9 | 10.263 |
| 1010 | S3, S9 | 10.379 |
| 1011 | S5 | 10.500 |
| 1100 | S9 | 10.600 |
| 1101 | S8 | 10.714 |
| 1110 | S10 | 10.777 |
| 1111 | None | 11.000 |

It can be appreciated that the unit 31 therefore enables the resistance of the resistor R0 to be determined, with a precision and within a range that are determined by the number of switch control signal codes, to enable a positive or negative slope of the reference voltage characteristic over temperature to be compensated, to provide a substantially flat characteristic as indicated by the line 21 in FIG. 2.

FIG. 5 illustrates by way of example one form of the resistor network and switch unit 34 for providing a nominal resistance of about 66 kΩ for the resistor R3. As shown in FIG. 5, the unit 34 comprises a 61 kΩ resistor, a lower end (as illustrated) of which forms one terminal of the resistor R3, connected in series with a plurality of 1 kΩ resistors only three of which are shown. For example, there can be ten 1 kΩ resistors. Junctions between successive resistors in the series chain, and the top end (as illustrated) of the resistor chain, are connected via respective ones of, in this example, eleven switches to a line forming another terminal of the resistor R3.

In this example, one of the switches is closed in response to a respective one of eleven 4-bit switch control signal codes (the other 5 codes being unused) supplied from the unit 31 to the decoder 36, not shown in FIG. 5, so that the 4-bit code in this example selects a value of the resistor R3 from 61 kΩ to 71 kΩ in steps of 1 kΩ. This enables the reference voltage to be trimmed in steps of about 19 mV, i.e. to within about ±10 mV of a nominal bandgap reference voltage of for example 1.215V. It can be appreciated that smaller resistance steps and/or a larger number of switch control code values can be used to provide an even more precise value of the reference voltage.

It can also be appreciated that the functions of the decoder can be incorporated into the arrangement of the respective resistor network and switch unit. For example, the resistor R3 can instead be constituted by a fixed resistor in series with four resistors having binary-weighted resistances (e.g. 8, 4, 2, and 1 kΩ), these four resistors being selectively bypassed by respective ones of four switches which are controlled by respective bits of the four-bit code provided by the test and control unit 31. Thus in this case the decoder is constituted by the binary weighting of the four resistors.

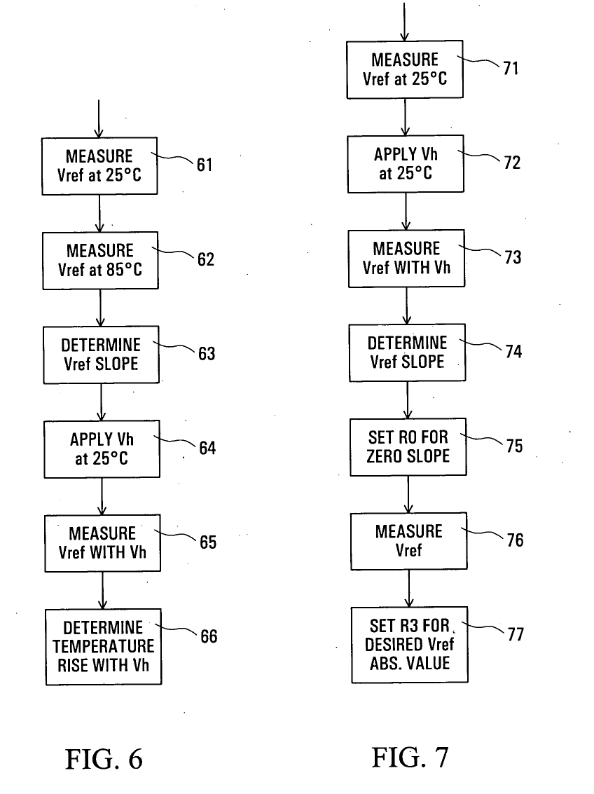

The arrangement of the IC 30 as described above with reference to FIGS. 3 to 5, including the resistor network and switch units 33 and 34, decoders 35 and 36, and heater 37 all on the IC chip, facilitates trimming of the resistors R0 and R3 using a method for example as described below with reference to FIGS. 6 and 7. It can be appreciated that, if desired, other resistors can be trimmed in a similar manner.

The trimming method comprises two sequences, which are illustrated by the steps of FIGS. 6 and 7 respectively. The sequence of FIG. 6 is carried out for only one IC 30 from a wafer comprising many such ICs, and makes use of an oven or other heating environment externally of the IC. The sequence of FIG. 7 is subsequently carried out for each IC from the wafer, and does not require an oven or other heating environment externally of the ICs. The disadvantages of conventional trimming arrangements using large ovens are therefore substantially avoided.

Conveniently, in the sequence of steps of FIG. 6, and in the sequence of steps of FIG. 7 up to the step 75 for the resistor R0 and up to the step 77 for the resistor R3, the test and control unit 31 supplies 4-bit switch control signal codes to the decoders 35 and 36 to select the nominal or middle resistance values of these resistors R0 and R3.

Referring to FIG. 6, in a first step 61 the output voltage Vref of one IC 30 from a wafer is measured at a first temperature, assumed here to be an ambient temperature of 25° C. In a second step 62 the output voltage Vref of this IC is measured at a second temperature, assumed here to be an elevated temperature of 85° C. Accordingly, at least the step 62 is carried out in an oven or other controlled heating environment. The output voltage Vref is measured, to a desired accuracy, in these and other steps of the method using the test and control unit 31, connected as shown in FIG. 3.

In a step 63, the unit 31 determines a slope of the output voltage Vref with respect to temperature. With the bandgap curvature compensation as described above, and before trimming of the resistor R0, the characteristic of the output voltage Vref against temperature is substantially linear. Accordingly, the slope (which may be positive, negative, or zero) is easily determined by the unit 31 by dividing the difference in the output voltage by the difference in temperature for the steps 61 and 62.

The remaining steps in the sequence of FIG. 6, and all of the steps in the sequence of FIG. 7, are conveniently carried out at the ambient temperature of, in this example, 25° C., and no further external heating of the ICs is required.

In a step 64, the unit 31 then applies a given heater supply voltage Vh to the heater 37 of the IC 30. After any time required for temperature stabilization within the IC 30, in a step 65 the unit 31 measures the output voltage Vref produced by the bandgap reference of the IC 30 with the voltage Vh applied to the on-chip heater. In a step 66 the unit 31 then determines a temperature rise, above the ambient temperature, of the bandgap reference due to the applied heating voltage Vh. This temperature rise is given by the difference in measured values of the output voltage for the steps 61 and 65 divided by the slope determined in the step 63.

Referring to FIG. 7, the sequence of successive steps 71 to 77 illustrated therein is carried out for each IC from the wafer, for example one at a time in turn, except that the steps 71 to 74 need not be carried out for the one IC 30 for which measurements have already been made in the sequence of FIG. 6.

In the step 71, for each IC the output voltage Vref is measured at the ambient temperature, again assumed here to be 25° C. In the step 72, the unit 31 then applies to the heater 37 of the IC 30 the same given heater supply voltage Vh as in the step 64 in the sequence of FIG. 6 as described above. After any time required for temperature stabilization within the IC 30, in the step 73 the unit 31 measures the output voltage Vref produced by the bandgap reference of the IC 30 with this voltage Vh applied to the on-chip heater.

In the step 74 the unit 31 determines the slope of the output voltage Vref with respect to temperature, by dividing the difference in the output voltage for the steps 71 and 73 by the temperature rise due to the heater voltage Vh as determined in the step 66 as described above.

Having determined the slope of the output voltage characteristic with temperature, in the step 75 the test and control unit 31 determines an appropriate resistance value of the resistor R0 to minimize the slope and make it substantially zero. More particularly, as successive small ranges of slope can be compensated by respective resistance values of the resistor R0 as described above, the unit 31 uses a look-up table to provide the appropriate 4-bit code in response to the determined slope. This 4-bit code is decoded by the decoder 35 to control the switches S1 to S11 as described above, so that the linear slope becomes substantially zero, i.e. the output voltage Vref of the IC 30 becomes substantially independent of temperature as shown by the relatively flat line 21 in FIG. 2.

In the step 76, the unit 31 measures the (slope-compensated) output voltage Vref of the IC 30. This is conveniently done at ambient temperature without the heating voltage Vh applied, but this is not critical because the output voltage Vref is now substantially independent of temperature.

In the step 77 the unit 31 determines an appropriate resistance value of the resistor R3 to provide a desired absolute value of the output voltage Vref. As described above, each change by 1 kΩ of the resistance of the resistor R3 corresponds to a change of the output voltage Vref by a fixed amount of for example about 19 mV. Accordingly, the unit 31 can use another look-up table responsive to the measured output voltage Vref, or its difference from the desired absolute value, to determine an appropriate 4-bit code to minimize this difference and make it substantially zero.

The resulting switch settings are stored permanently in the IC in any desired manner, for example using an OTP (one-time programmable) or other ROM (read-only memory) on the die to control CMOS switches constituting the switch units, or fusible links constituting the switches. The switch settings therefore remain after disconnection of the IC 30 from the test and control unit 31. Consequently, the bandgap reference 32 of each IC 30 provides an accurate and temperature-independent reference output voltage Vref.

As observed above, the bandgap reference circuit 32 and the on-chip heater 37 can be thermally isolated from other parts of the IC 30, for example in known manner by etching to form a cavity over which the circuit 32 and heater 37 are provided on a silicon bridge. Such thermal isolation techniques are not necessary but may provide more rapid heating and stabilization of the circuit 32.

Although the invention is described above in the context of a bandgap reference, it can be appreciated that it also applies to other types of circuit for producing a reference voltage dependent upon a resistance of a resistor, especially where the reference voltage is dependent upon temperature of the reference voltage circuit and the resistance of the resistor determines a temperature dependence of the reference voltage.

Thus although particular embodiments of the invention are described above in detail, it can be appreciated that numerous modifications, variations, and adaptations may be made without departing from the scope of the invention as defined in the claims.

1. An integrated circuit comprising:
a circuit for producing a reference voltage at an output of the integrated circuit, the reference voltage being dependent upon a resistance of a resistor; and
a resistor network and switch unit constituting said resistor, the resistor network and switch unit comprising a plurality of resistors and a plurality of switches;
the plurality of switches being responsive to control signals supplied to the integrated circuit to interconnect the plurality of resistors to provide different resistance values for said resistor.

2. An integrated circuit as claimed in claim 1 wherein the plurality of resistors are connected in series and the plurality of switches are arranged for selectively bypassing different ones of the plurality of resistors.

3. An integrated circuit as claimed in claim 1 wherein the reference voltage is dependent upon a temperature of the reference voltage circuit, the resistance of said resistor determines a temperature dependence characteristic of the reference voltage, and the integrated circuit includes a heater for selectively heating the reference voltage circuit.

4. An integrated circuit as claimed in claim 1 and including a decoder for producing decoded signals for controlling the plurality of switches from said control signals supplied to the integrated circuit.

5. An integrated circuit as claimed in claim 1 wherein the reference voltage circuit comprises a bandgap reference voltage source.

6. An integrated circuit comprising:
a bandgap reference voltage source for producing a reference voltage at an output of the integrated circuit, the reference voltage being dependent upon a temperature of the bandgap reference voltage source with a characteristic dependent upon a resistance of a resistor of the bandgap reference voltage source; and
a resistor network and switch unit constituting said resistor, the resistor network and switch unit comprising a plurality of resistors and a plurality of switches;
the plurality of switches being responsive to control signals supplied to the integrated circuit to interconnect the plurality of resistors to provide different resistance values for said resistor.

7. An integrated circuit as claimed in claim 6 and including a heater for selectively heating the bandgap reference voltage source.

8. An integrated circuit as claimed in claim 6 and including a decoder for producing decoded signals for controlling the plurality of switches from said control signals supplied to the integrated circuit.

9. An integrated circuit as claimed in claim 6 wherein an absolute value of the reference voltage is dependent upon a resistance of a second resistor of the bandgap reference voltage source, the integrated circuit including a second resistor network and switch unit constituting said second resistor and comprising a plurality of resistors and a plurality of switches, the plurality of switches being responsive to control signals supplied to the integrated circuit to interconnect the plurality of resistors to provide different resistance values for said second resistor.

10. An integrated circuit as claimed in claim 9 and including a heater for selectively heating the bandgap reference voltage source.

11. An integrated circuit as claimed in claim 9 and including a second decoder for producing decoded signals for controlling the plurality of switches of the second resistor network and switch unit from said control signals supplied to the integrated circuit.

12. An integrated circuit as claimed in claim 10 wherein the bandgap reference voltage source includes a curvature compensation circuit for compensating for variation of the reference voltage with temperature.

13. An integrated circuit as claimed in claim 12 wherein the integrated circuit is implemented using CMOS technology.

14. A method of determining a resistance value of a resistor in a circuit for producing a reference voltage, the circuit being part of an integrated circuit also including a heater for heating the reference voltage circuit, the reference voltage having a dependence upon temperature determined by the resistance value of said resistor, comprising the steps of:
determining said dependence upon temperature from two measurements of the reference voltage at different temperatures with a temperature difference determined by a controlled heating of the reference circuit using said heater;
determining, from the determined dependence upon temperature, a resistance value of said resistor to minimize the temperature dependence of the reference voltage; and
setting the resistance value of said resistor to the determined resistance value.

15. A method as claimed in claim 14 wherein the step of setting the resistance value of said resistor to the determined resistance value comprises controlling switches of a resistor network and switch unit constituting said resistor.

16. A method as claimed in claim 15 wherein the step of controlling switches comprises supplying control signals to the integrated circuit and decoding the control signals in a decoder of the integrated circuit.

17. A method as claimed in claim 14 wherein the two measurements of the reference voltage at different temperatures are at an ambient temperature and at a temperature above-ambient temperature produced by supplying a predetermined voltage to said heater.

18. A method as claimed in claim 17 and including an initial step of determining a temperature rise produced by supplying said predetermined voltage to said heater, said initial step comprising the steps of:
determining said dependence upon temperature from measurements of the reference voltage at different temperatures determined externally of the integrated circuit; and
determining said temperature rise from the determined dependence upon temperature and measurements of the reference voltage with and without said predetermined voltage supplied to said heater.

19. A method of determining a resistance value of a resistor in a circuit for producing a reference voltage, the circuit being part of an integrated circuit, the reference voltage being dependent upon the resistance value of said resistor, comprising the steps of:
measuring the reference voltage at an output of the integrated circuit;
determining from the measured reference voltage a resistance value of said resistor to produce a desired value of the reference voltage; and
setting the resistance value of said resistor to the determined resistance value by controlling switches of a resistor network and switch unit constituting said resistor.

20. A method as claimed in claim 19 wherein the step of controlling switches comprises supplying control signals to the integrated circuit and decoding the control signals in a decoder of the integrated circuit.
